(19) United States
(12) Patent Application Publication
(10) Pub. No.: US 2026/0099870 A1
(43) Pub. Date: Apr. 9, 2026

(54) Product Recommendation Systems and Methods

(71) Applicant: Dahlia Labs, Inc., Hillsborogh, CA (US)

(72) Inventors: Daniel Joseph Arcand Cary, Kirkland, WA (US); Brad William Rathke, Mount Kisco, NY (US)

(21) Appl. No.: 19/347,590

(22) Filed: Oct. 1, 2025

Related U.S. Application Data
(60) Provisional application No. 63/703,059, filed on Oct. 3, 2024.

(51) Int. Cl. G06Q 30/0601

(52) U.S. Cl. CPC G06Q 30/0627; G06Q 30/0631

(57) ABSTRACT

Systems and methods for product recommendation are described. One aspect includes receiving a user selection of a first item, and a user request for an online search based on the first item. The online search may include at least one modification to at least one property of the first item. The online search may be conducted, and one or more results of the online search may be presented to the to the user. The results may include at least a second item that differs from the first item with respect to the at least one property.

### BACKGROUND

This application claims the priority benefit of provisional Ser. No. 63/703,059 titled “Product Recommendation Systems and Methods” filed on Oct. 3, 2024, the disclosure of which is incorporated by reference herein in its entirety.

### TECHNICAL FIELD

The present disclosure relates to systems and methods that enable enables users to use voice or typed/written natural language to modify product search results or product offerings in one or more selected ways. The differences can be based on structured data, stylistic changes, or changes to the circumstances in which the item is appropriate.

### BACKGROUND ART

Current online shopping and product recommendation systems do not provide a user with options to modify a search result for a specific item. For an existing item found by the user online, the user may not like certain aspects of the item (e.g., color, fabric, etc.). The current state of the art does not enable such a user to initiate a subsequent search using the item as a reference, while requesting a search for similar items that differ from the reference item in one or more categories.

### SUMMARY

Aspects of the invention are directed to systems and methods for enabling a user to initiate a search based on modifying one or more properties of an existing item.

One method includes receiving a user selection of a first item, and receiving a user request for an online search based on the first item. In an aspect, the online search request includes at least one modification to at least one property of the first item. The online search may be conducted, and one or more results of the online search may be presented to the user. In an aspect, the results of the online search include at least a second item that differs from the first item with respect to the at least one property.

In an aspect, the at least one property can be any combination of a style, a color, a price, a brand, and a construction material.

In an aspect, the user request is processed by at least one machine learning (ML) processor using natural language processing (NLP).

In an aspect, conducting the online search includes inputting the at least one modification to an embedding model configured to encode the at least one modification. The embedding model may combine the encoded at least one modification with parameters associated with the online search request, and an ML model may predict a region of latent search space that includes at least the second item. The ML model may be trained to perform the predicting.

Additional parameters such as seasonal appropriateness and qualities based on composition may be included in the online search. The qualities based on composition may include any combination of care instructions and materials.

In an aspect, the modification is any combination of:
A near modification associated with a relatively minor change to the at least one property,
A far modification associated with a relatively large change to the at least one property, and
A subcategorical modification based on the second item being in a different category as compared to the first item.

The near modification may be any of a pattern change, a feature change, or a style change. The far modification may be any of a color change, a pattern change, a style change, or a silhouette change. The subcategorical modification may be associated with the second item sharing a similar pattern as the first item.

In one example, the first item is a jacket and the second item is a blouse.

Aspects of the invention include apparatuses and/or systems that implement the above methods.

### BRIEF DESCRIPTION OF THE DRAWINGS

The patent or application file contains at least one drawing executed in color. Copies of this patent or patent application publication with color drawings will be provided by the office upon request and payment of the necessary fee.

Non-limiting and non-exhaustive embodiments of the present disclosure are described with reference to the following figures, wherein like reference numerals refer to like parts throughout the various figures unless otherwise specified.

FIG. 1 is a block diagram depicting a computer architecture of a product recommendation system.

FIG. 2 is a process flow diagram depicting a product recommendation process.

FIGS. 3A and 3B are process flow diagrams depicting a training process for an ML system configured to perform a product recommendation.

FIG. 4 is a block diagram of a computing system.

FIG. 5 is a flow diagram depicting a method to generate a product recommendation.

FIG. 6 is a view depicting a seed item and corresponding pivots.

FIG. 7 is a view depicting a seed item and corresponding pivots.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system. ” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention described herein are related to creating examples of high-quality pivots (i.e., item property modifications) that can be used as training data for machine learning models. Based on this training, these systems and methods can be configured to receive a seed product and user pivot instruction(s) and predict the embedding of a product that matches a combination of that seed product and the instruction(s).

One aspect includes systems for capturing user intent, interpreting user intent and routing it to the correct subcomponents. The subcomponents themselves work together to retrieve relevant products for the user. One aspect includes systems for collecting user interaction data and using it to improve the other systems.

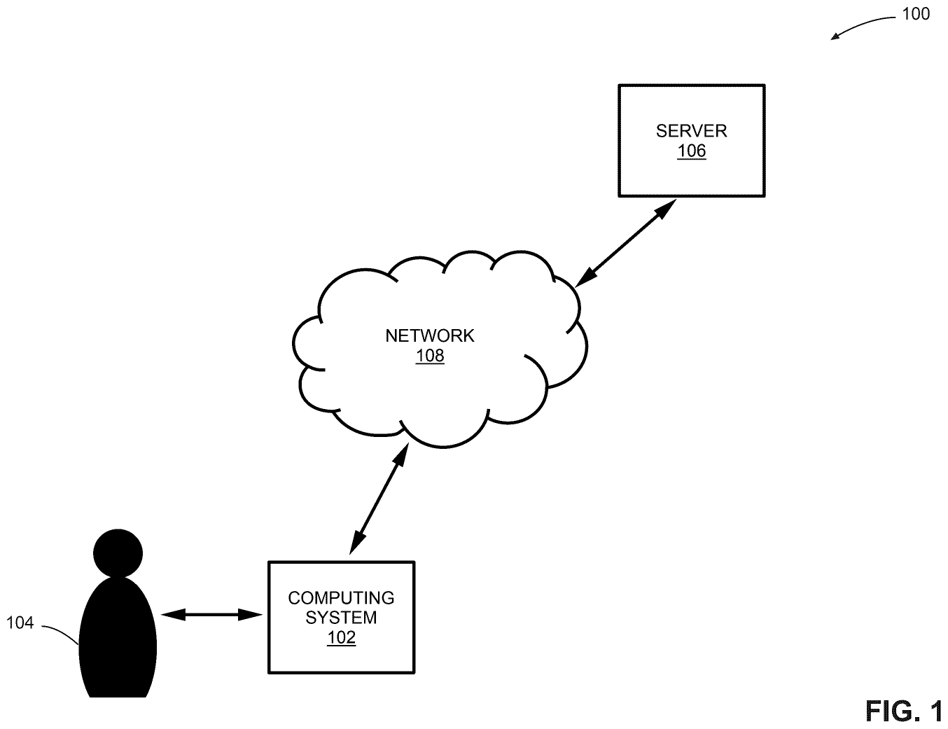

FIG. 1 is a block diagram depicting a computer architecture of a product recommendation system 100. As depicted, product recommendation system 100 includes computing system 102 communicatively coupled to server 106 via network 108. Computing system may be any of a desktop computer, a laptop computer, a mobile computing device (e.g., a tablet or a mobile phone), or some other kind of computing system. In general, the term “computing system” as used herein refers to any kind of device with at least one processor, a memory, and a network interface. In an aspect, network 108 is a computer network such as the Internet, a local area network (LAN), a wide area network (WAN), or some other kind of network that may be implemented by using any combination of wired or wireless connections. Server 106 may be a computer server implemented using server technology as known in the art.

In an embodiment, product recommendation system 100 is configured to provide user 104 with an ability to initiate an online search to recommend one or more items of interest to user 104. User 104 may provide details about an item of interest to the user (e.g., a shirt, a pair of shoes, or some other item available for sale online). Details of the item (also referred to as a “seed item” or a “seed product”) may be obtained by the user via a previous online search, or from browsing a product website. At the same time, the user may not like one or more qualities or properties associated with the item (e.g., a color, a construction material, a style parameter, and so on). User 104 may input item details to computing system 102. These item details may be transmitted to server 106 via network 108.

In an aspect, user 104 provides additional information describing the one or more qualities or properties that the user wishes to change. These qualities or properties, also known as “pivots”, may be input by user 104 into computing system 102. These pivots may be transmitted to server 106 via network 108. Server 106 may use the seed product and pivots to search for one or more items that meet the requirements/requests of user 104.

Aspects of product recommendation system 100 may include one or more trained machine learning (ML) components configured to process inputs with the seed product and the product, and accordingly conduct the online search. These trained ML components may be configured to be deployed on any combination of computing system 102 and server 106. For example, an application software running on computing system 102 may implement one or more trained ML components. Similarly, server 106 may implement one or more machine learning components. In an embodiment, server 106 implements a searchable e-commerce website.

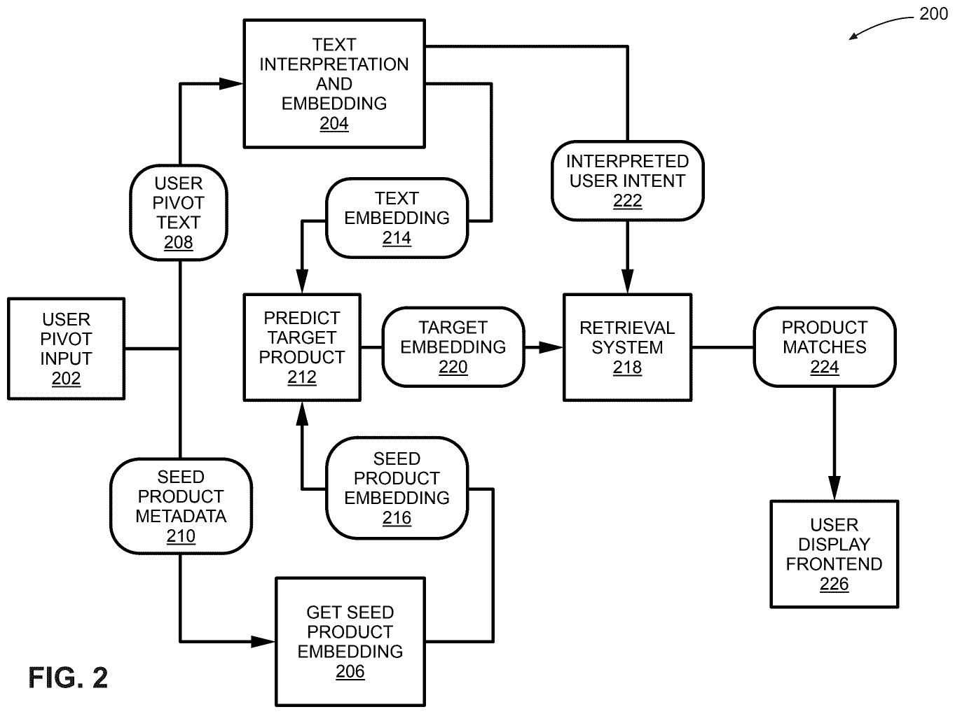

FIG. 2 is a process flow diagram depicting a product recommendation process 200, as implemented by product recommendation system 100. In an aspect, product recommendation process 200 is implemented using one or more trained ML components operating on any combination of computing system 102 and server 106.

An e-commerce website (e.g., as implemented on server 106 and displayed to user 104 on computing system 102) can be augmented with many potential entry points for pivot features received from user 104. Such e-commerce sites can add entry points in natural language interfaces where a user (e.g., user 104) asks to pivot from one product to another (i.e., requests a search based on a seed item based on one or more user pivots via inputs from computing system 102).

To facilitate user pivot input, an entry point (e.g., a text box) can be added on product listings displayed on the e-commerce website. Such an entry point can also be added on individual search results. Entry points can be added to collections of multiple products. In one aspect, the e-commerce site provides a way for user 104 to indicate interest in one or more products plus a way in which to enter input as to what they wish was different about the product. Common or suggested pivots (“more like this”, “this but cheaper”, “under $200”, etc.) can even be provided as suggested chips, dedicated buttons, or prefilled input fields on the e-commerce website.

Once user 104 enters their pivot instruction, the associated user pivot text 208 is received by text interpretation and embedding 204. Text interpretation and embedding 204 can either process the user pivot text 208 directly or decompose the user pivot text 208 such that it can be used in a modular system. Machine learning pivots models that are trained on structured information, attributes, and product embeddings can interpret most user instructions directly, but higher quality results can be achieved by decomposing the user's instruction and passing off parts of it to dedicated systems. Text interpretation and embedding 204 may output text embedding 214 that is input to predict target product 212.

At the same time, metadata associated with the seed product (210) is received as a part of user pivot input 202 and input to get seed product embedding module 206. Get seed product embedding module 206 may process seed product metadata 210 and output seed product embedding 216 to predict target product 212. Predict target product 212 may process text embedding 214 and seed product embedding 216 to generate target embedding 220, which is input to retrieval system 218.

In an aspect, text interpretation and embedding 204 also produces interpreted user intent 222 from user pivot text 208, and outputs interpreted user intent 222 to retrieval system 218. Interpreted user intent 222 is an ML/NLP interpretation of the needs of user 104. Retrieval system 218 may process target embedding 220 and interpreted user intent 222 to generate one or more product matches 224 that may be displayed on user display frontend 226 (e.g., on computing system 102). User display frontend 226 may be a visual display monitor (e.g., a screen of computing system 102).

Data structures associated with product recommendation system 100 may include:
Structured data—e.g., Price, sizing, etc.
Attributes data—e.g., Brand, material, care instructions, etc.
Stylistic information—e.g., fit, silhouette, embellishments, adjectives, etc.

An LLM, set of heuristics, or other machine learning system can be used to decompose the user's raw input (e.g., user pivot input 202) and route it to the correct subsystem (e.g., text interpretation and embedding 204 or get seed product embedding 206). For subcomponents that use ML systems to process the decomposition of the user's instruction, the portion of the user's instruction that is to be processed by the respective subcomponent may be embedded (e.g., 214, 216) before running it through the respective model.

In one aspect, an LLM is configured to split the user instruction (e.g., user pivot input 202) into structured data, attributes data, and stylistic information. Structured data and attributes data are decomposed into a set of search filters (i.e., interpreted user intent 222) and passed to the retrieval system 218. The stylistic part of the instruction is embedded via a call to an ML embedding service and then concatenated with the seed product embedding 216 before being run through a stylistic pivot machine learning model (i.e., predict target product 212) to produce a predicted embedding of a product that matches the user's instruction (i.e., target embedding 220).

To retrieve ideal products for the user (e.g., by retrieval system 218), the subcomponents depicted in product recommendation process 200 work in concert to retrieve products for the user that the user is expected to like. The trained machine learning model may be configured to produce the embedding of a product that a user (e.g., user 104) is likely to like (e.g., target embedding 220) in response to whatever portion of the user's message was decomposed and processed by that model along with the seed product information/embedding (214/216, respectively). A vector search can be used to retrieve products from an associated e-commerce catalog that are similar to this predicted target product embedding in vector space. Structured data and attributes data can be fed into that search system as constraints and filters. If the user's input is decomposed into a maximum price that they are willing to pay and a specific brand that they are looking for, then a maximum price filter can be set to only show products under that threshold and a brand filter can be applied to only show results from that brand.

Personalization and reranking systems can then be optionally applied on top of the retrieved results to further improve the quality. The reranking system can reorder the results to provide a diversity of desirable products for the user 104 and a personalization system can be used to apply known information about the user from past interactions as input signals to how the results are reordered.

In an aspect, product recommendation system 100 may be configured to collect user interaction data associated with user 104, and use the user interaction data to improve functionalities of one or more subsystems associated with product recommendation system 100. Examples of such subsystems are the subsystems presented in FIG. 2.

Based on user interaction of user 104 with product recommendation system 100, these user interactions with the system can be used to iteratively improve the quality of the product recommendation system 100. If a user (e.g., user 104) is presented with multiple results for each pivot, then the products that they interacted with (through saves, purchases, likes, click throughs, or any other positive signal) can be used as new training examples for the machine learning models associated with product recommendation system 100. The seed product (derived from an initial online search by user 104 or by user 104 browsing an e-commerce website) is the original product, the pivot instruction 202 is the instruction text the user entered (or the decomposed portion used in the machine learning models), and the target product is the product that that user interacted with in a positive manner.

Essentially, “Pivots” enable users to use voice or written natural language to modify products in some way. The differences can be based on structured data, stylistic changes, or changes to the circumstances in which the item is appropriate. This is depicted in product recommendation process 200.

### Basic Example

A user (e.g., user 104) sees a product that they like on an e-commerce website, but there is some aspect of the product that they do not like. For this example, imagine a user finding a t-shirt with an interesting pattern, but it is sold with a V-neck collar, costs $600, and is too thin.

The user indicates that they would like to perform a pivot (i.e., a search for a similar item, but with one or more modified properties). They can indicate this desire by clicking an icon on the product webpage or telling an artificial intelligence (AI) agent associated with the ML systems included in product recommendation system 100 that they like the initial product but wish it was different in some way. The user can provide this information via written text or spoken language. In the above example, user 104 may describe the differences they would like to see. “In a crew neck, thicker material, and under $200”.

Product recommendation system 100 translates this information into a set of modifications that need to be made to the product using ML models. A user instruction that combines stylistic changes, attribute changes, and structured data changes can be deconstructed into each of its constituent parts and passed to specialized systems for processing (e.g., to text interpretation and embedding 204).

Stylistic changes are fed into an embedding model (e.g., get seed product embedding 206) to encode them. The encoded stylistic instruction is then combined with the embedding of the original product and fed into an ML model (e.g., predict target product 212) that is trained to predict the region of latent space that combines products that meet that new description.

Attribute changes like seasonal appropriateness or qualities based on composition (care instructions, materials) are handled either through being turned into filters or embedded into vector space and used to retrieve products that live in similar vector spaces in conjunction with the transformed stylistic vector.

Structured data changes such as price, brand, tags, or materials are translated into faceted filters that limit the types of products that can be returned in the results.

A combined vector and faceted search is performed based on the previous steps and the resultant products are displayed to users. In this case, the user would see crew neck shirts, made of thicker materials, that cost less than $200 and have similar patterns to the original product.

### Workflow

### * The Stylistic Transformation

Pairs of products that share certain characteristics are selected from an existing corpus by looking at shared attributes and the similarity of their embeddings. These pairs could be selected many different ways.

A machine learning system associated with product recommendation system 100 is used to generate examples of user instructions (pivot text) that a user might enter to go from the first product to the second product. The system can look at any combination of the product embeddings, metadata, images, or data derived from the above.

An ML model is trained to take the combination of the first product's embedding into vector space and the embedding of the synthetic pivot text. This model attempts to predict the embedding of the target product that was used as a reference to generate the synthetic pivot text.

With sufficient training data, the model learns to take any product and user instruction and to identify the region of vector space that contains products that match that transformation.

### * The Attribute Transformation

Products include metadata such as seasonality, materials, care instructions, or any other factual information.

When a user enters an instruction that requires an attribute change, the model that translates instructions into modifications of these factual datapoints. E.g., Season=Summer to Season=Winter, or Color=Red to Color=Blue. The resultant attributes can either be used as filters for exact matches or embedded and used to calculate semantic similarity (e.g., Fall is closer to Winter than summer is to Winter so results for Fall should show up more prominently).

### * The Structured Data Transformation

The ML system that interprets the user's instruction is provided with an example output structure that it attempts to fill with relevant information. The most common piece of structured data that users want to change is price. This structured data is then fed into existing search filtering systems to constrain the results that can be retrieved.

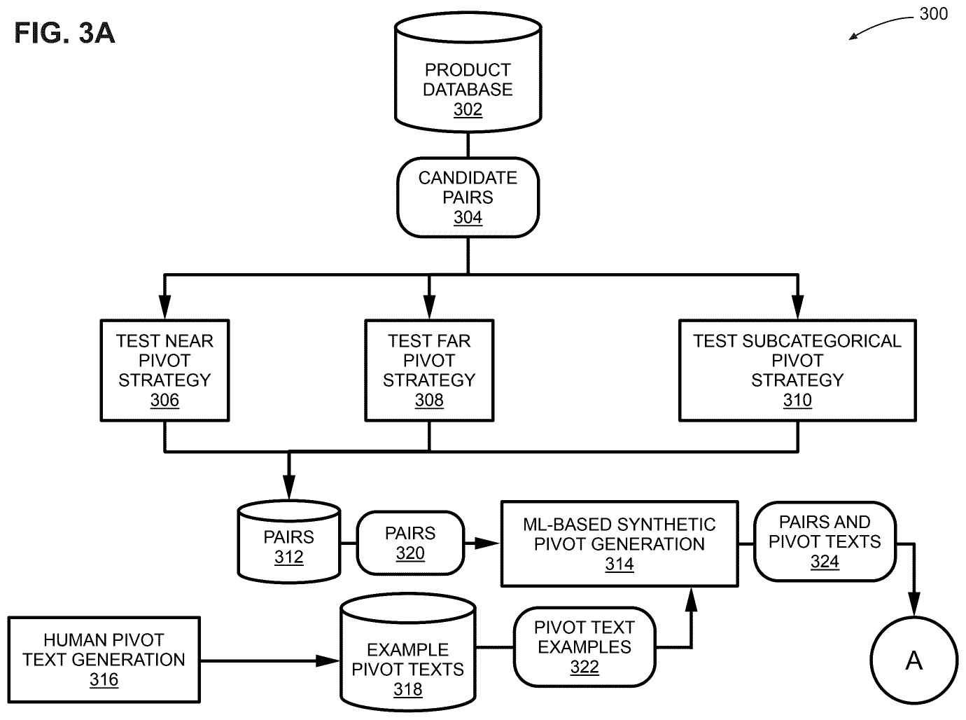

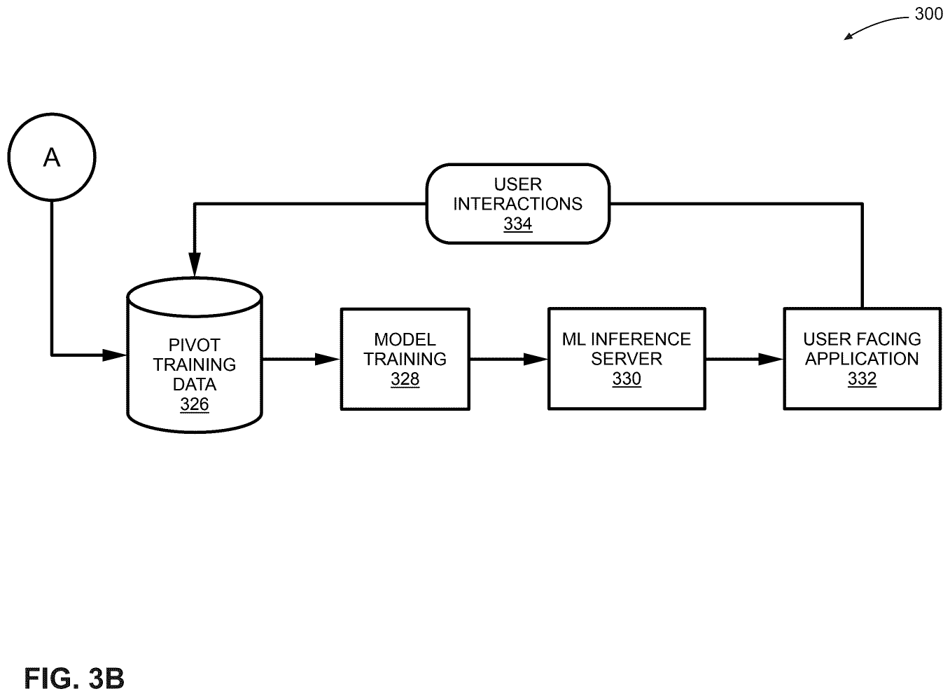

FIGS. 3A and 3B are process flow diagrams depicting a training process 300 for an ML system configured to perform a product recommendation. Training process 300 may be used to configure an ML system associated with product recommendation system 100 to implement the product recommendation process 200.

As depicted in FIG. 3A, product database 302 may be configured to store data about a plurality of products. Of these products, a plurality of candidate pairs 304 may be generated. Examples of candidate pairs include:
Two t-shirts of a similar style that differ with respect to construction material and brand.
A pair of shoes in a similar style, with one pair being lace-ups and the other pair being slip-ons.

Each of candidate pairs 304 may be subject to:
Testing a near pivot strategy 306 associated with relatively small differences between the items in the candidate pairs,
Testing a far pivot strategy 308 associated with relatively large differences between the items in the candidate pairs, and
Testing a subcategorical pivot strategy 310, where the items are in different categories.

Results from testing processes 306, 308 and 310 may be used to generate pairs 320 that are stored in pairs database 312.

Pairs 320 can be retrieved pairs database 312 to generate ML-based synthetic pivots 314. These synthetic pivots are artificially-created pivots (e.g., simulated pivots) used to train the associated ML system. The ML-based synthetic pivot generation process 314 may also receive pivot text examples 322. Pivot text examples 322 may be human-generated pivot text 316 stored in example pivot texts database 318. Examples of human pivot text include speech-to-text inputs from user 104, search keywords typed into a text box on a product webpage by user 104, etc. ML-based synthetic pivot generation 314 may process the example pivot texts using NLP methods.

In an aspect, ML-based synthetic pivot generation 314 forms an association (grouping) between a pivot pair from pairs 320, and a corresponding pivot text example from pivot text examples 322. ML-based synthetic pivot generation 314 may generate pairs and pivot text groups 324 corresponding to such groupings between pairs 320 and pivot text examples 322.

Referring now to FIG. 3B, the pairs and pivot texts 324 may be used as pivot training data to populate pivot training data database 326. This pivot training data from pivot training data database 326 may be used for model training 328 of an ML model. The ML model outputs are used to train an ML inference server 330, which generates product recommendation outputs to a user (e.g., user 104) via user facing application 332. User 104 may interact with user facing application 332 (e.g., select one or more recommended products that might be of interest to user 104). These user interactions 334 may be used to update the pivot training data in pivot training data database 326, to improve the quality of the recommendations.

In an aspect, training process 300 creates examples of high quality pivots that can be used as training data for machine learning models associated with product recommendation system 100.

The first step in creating the pivots feature is creating examples of high quality pivots that can then be used to train machine learning models. These examples need to include 3 components:

A “seed product” that the user is interested in, but wants to change in some way.

A “pivot instruction” that the user enters to describe what they wish was different about the product.

A “target product” that represents the ideal product.

Once the feature is live in front of users, user interaction data (e.g., user interactions 334) can be used to create training data such as using the products that users save or purchase after pivoting as examples of ideal target products for a given pivot. However, it is also essential to train the initial models without user interaction data. This is achieved by pairing likely products that could theoretically be pivoted between and then generating a pivot instruction that a user might enter to go from one product to the other, as depicted in FIG. 3A.

### Creating Pivot Pairs

The first step is to pair products together such that moving from one to the other would constitute a high quality pivot. This step uses existing metadata, attributes, and embeddings of those products (e.g. from product database 302). Metadata can include things like the brand of clothing or the price of the items. The attributes can include tags and taxonomy information. These attributes can be further augmented by using machine learning models to generate attributes for products based on the product imagery. The embeddings are dense representations of the products such that products that are close together in the embedding space are similar in the eyes of users. The embeddings can be based on the product images, textual information, structured data, or any combination thereof.

The second step is to create pairing strategies (e.g., pairs 320 stored in pairs database 312). A pairing strategy represents a type of pivot that a user might perform. The goal is to have a mix of strategies that represent all of the ways in which a user might want to move from one product to another. Examples of pairing strategies include:

Near pivots—Products within the same branch of the product taxonomy that have small differences in embellishments, patterns, or features. These products are referred to as “near pivots” because a shopper would need to be physically near to the seed and target products to spot the differences between them. Near pivots are analyzed via test near pivot strategy 306.

Far pivots—Products within the same branch of the product taxonomy that have significant differences in their colors, patterns, silhouettes, styles, etc. These products are referred to as “far pivots” because a shopper would be able to spot these differences from far away. Far pivots are analyzed via test far pivot strategy 308.

Subcategorical pivots—Products that are not in the same branch of the product taxonomy, but have commonalities in their other attributes. An example of a subcategorical pivot would be a jacket and a blouse that share the same pattern. Subcategorical pivots are analyzed via test subcategorical pivot strategy 310.

Once the pairing strategies have been established (e.g., after tests 306-310 have been completed and pairs 320 have been established), each product in the associated catalog is examined, and all of the products that could potentially be paired with it are identified based on one or more pairing strategies. The highest quality pairs are selected by selecting the candidates that are most similar to a given set of seed products based on an embedding similarity measure. Selecting based on similarity means that the corresponding products will be as close as possible to one another in the embedding space while still being candidates based on the implemented pairing strategies. This minimizes the differences outside of those included in the pairing strategies. The result is that seed and target product pairs that a user could theoretically pivot between have been generated.

### Generating Synthetic Pivot Instructions

Once the pairs 320 of seed and target products have been established, natural language instructions that could represent what a user would type in to pivot from the seed product to the target product need to be created. This can be accomplished through human raters, or by using machine learning models such as LLMs.

In either case, the task is to look at the product attributes, metadata, and/or images and to write an instruction that a user might type in to go from the first product to the second product. For diversity of language, it works best to have multiple examples of things users might type in to pivot between any two product pairs.

An aspect includes systems for training machine learning models that take in a seed product and user pivot instruction and predict the embedding of a product that matches that seed product+instruction. This is shown in human pivot text generation 316 stored in example pivot texts database 318.

Once ample synthetic training data has been generated, this data is used to train the machine learning models that create pivots such that product recommendation system 100 is configured implement the product recommendation process 200 to a user. User interaction data 334 can be used to generate new training data that can be used to refine and improve our machine learning models by updating pivot training data 326.

The ML models themselves can be built in many different ways. The important thing is that the input into the models includes information about the seed product such as the seed product embedding (e.g., in pairs 320) used in get seed product embedding 206, the synthetic pivot instruction or embedding thereof (e.g., pairs and pivot texts 324 generated by ML-based synthetic pivot generation 314), and the information about the target product such as the target product embedding (220). The simplest implementation of the pivot models takes the seed product embedding, an embedding of the pivot instructions, and the embedding of the target product. The embedding of the seed product and pivot text are combined, usually through concatenation) and fed through a network to predict the target product embedding.

While the model can learn to embed the pivot instruction, it can be simpler to use a separate embedding model to embed the user (or the synthetic) pivot instruction both during model training and when the feature is used in a production environment. As an example, a separate text embedding model will be used for the pivot text instruction.

More complicated models can be used that also include (or substitute) structured data about each product, metadata about each product, and/or the embedding of an image of each product's material/pattern/color.

In any setup, sufficient training will result in a model that can take in a seed product and pivot instruction and predict a representation of an ideal target product.

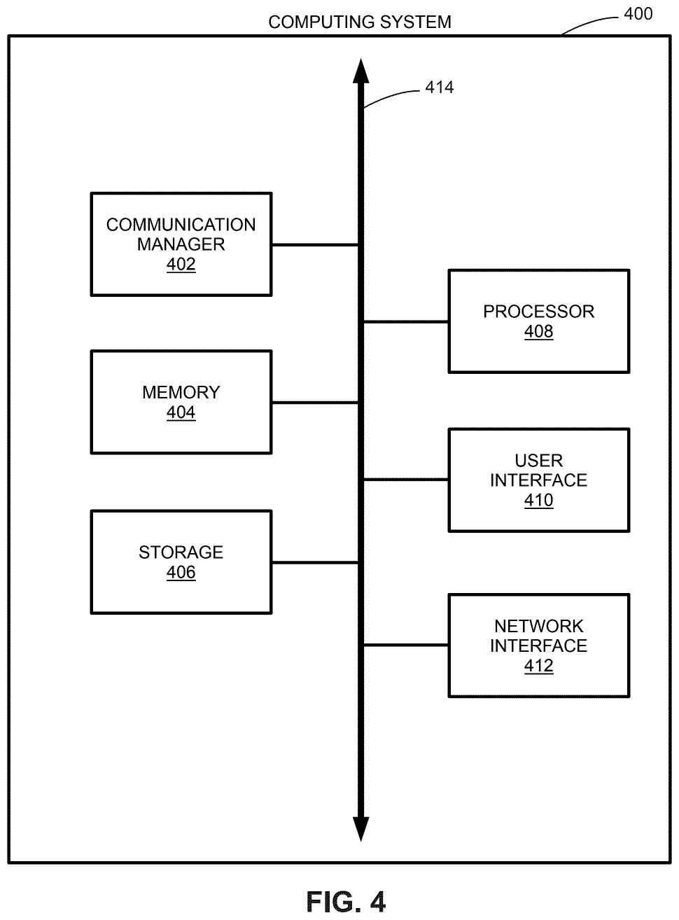

FIG. 4 is a block diagram of a computing system 400. As depicted, computing system 400 includes communication manager 402, memory 404, storage 406, processor 408, user interface 410, network interface 412, and system bus 414. Processing system 400 may be used to implement embodiments of product recommendation system 100. For example, computing system 400 may be used to implement any combination of computing system 102 and server 106.

In an aspect, communication manager 402 is configured to manage communication protocols and associated communication with external peripheral devices as well as communication with other components in computing system 400.

Memory 404 may be comprised of any combination of volatile and non-volatile memory components. Examples of components that may be used to implement memory 404 include random-access memory (RAM), read-only memory (ROM), electrically-erasable programmable read-only memory (EEPROM), flash memory, magnetic memory, optical memory, and so on. In an aspect, memory 404 includes a non-transitory computer medium. Memory 404 may include machine-readable instructions that may be executable by a processor such as processor 408. These machine-readable instructions, when executed by the processor 408, cause the processor 408 to perform one or more method steps of an embodiment described herein.

Computing system 400 may include storage 406, that further includes one or more long-term storage devices such as hard disk drives, magnetic drives, magnetic tape, optical storage media (e.g., compact disks (CDs) or digital versatile disks (DVDs)), and so on. Storage 406 may be implemented as a non-transitory computer-readable medium. Storage 406 may be configured to store data and/or instructions related to the operation of computing system 400.

A processor 408 included in some embodiments of computing system 400 is configured to perform functions that may include generalized processing functions, arithmetic functions, and so on. Processor 408 is configured to process information associated with the systems and methods described herein. Processor 408 may be configured as any combination of microcontrollers, microprocessors, digital signal processors (DSPs), field-programmable gate arrays (FPGAs), graphics processing units (GPUs), accelerated processing units (APUs), central processing units (CPUs), application-specific integrated circuits (ASICs), and so on. Processor 408 may be embodied as a single-core processor, or a multi-core processor. Processor 408 may be implemented as a centralized processor, or in a distributed manner (e.g., a distributed computing system).

User interface 410 allows other devices or a user to interact with embodiments of the systems described herein. User interface 410 may include any combination of user interface devices such as a keyboard, a mouse, a trackball, one or more visual display monitors, touch screens, incandescent lamps, LED lamps, audio speakers, buzzers, microphones, push buttons, toggle switches, and so on. User interface 410 may alco include interfaces such as USB, Thunderbolt and FireWire that enable computing system 400 to interface with different devices.

Network interface 412 may be used to interface computing system 400 with other computing devices and/or computer networks. Examples of computer networks include a local area network (LAN), a wide area network (WAN), the Internet, and so on. Network interface 412 may support any combination of wired and wireless connectivity/communication protocols such as Ethernet, Wi-Fi, Bluetooth, ZigBee, etc.

System bus 414 communicatively couples the different components of computing system 400, and allows data and communication messages to be exchanged between these different components.

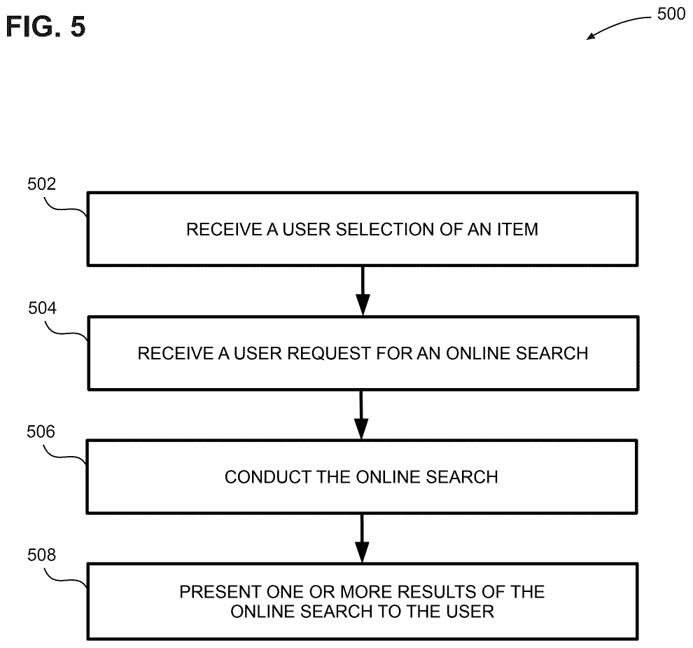

FIG. 5 is a flow diagram depicting a method 500 to generate a product recommendation. Method 500 may be implemented by product recommendation system 100.

In an aspect, method 500 includes receiving a user selection of an item (502). For example, user 104 may browse for items on an e-commerce website or perform a preliminary online search for the item, on computing system 102. User 104 may select the item (i.e., the seed item) from the browsing session or based on the preliminary online search.

Method 500 may include receiving a user request for an online search (separate from the preliminary online search) (504). User 104 may not be completely satisfied with one or more properties of the selected (seed) item. For example, the user may want the item in a different color. Based on this dissatisfaction, user 104 may initiate an online search via computing system 102, with this online search including at least one modification to at least one property of the item (e.g., color).

Method 500 may include conducting the online search using the at least one modification (506), and presenting one or more results of the online search to the user (508). For example, server 106 may conduct the search using, for example, product recommendation process 200 to implement 506 and 508.

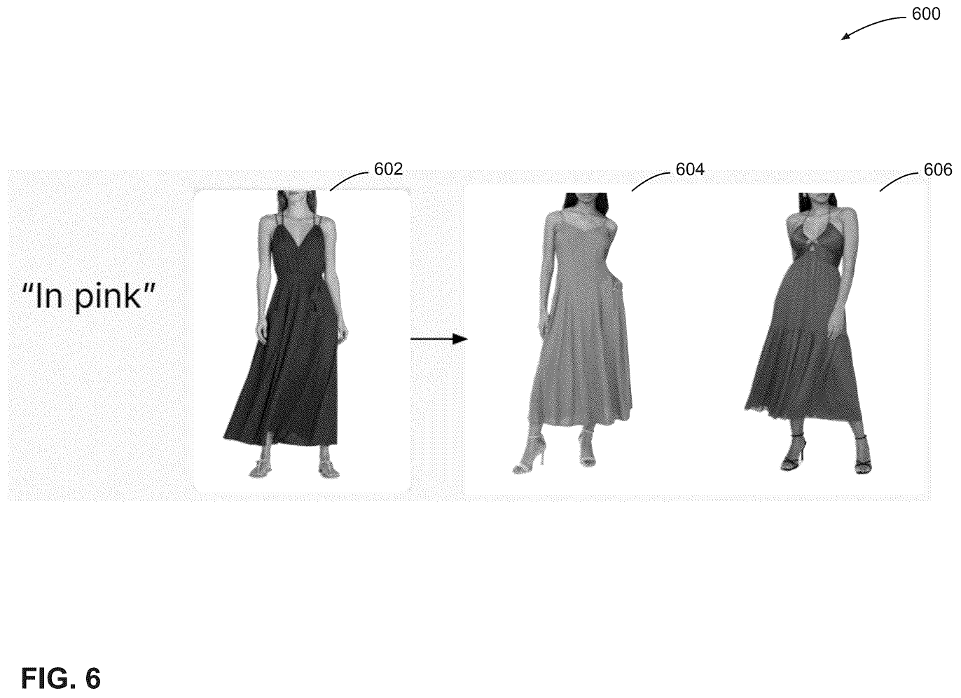

FIG. 6 is a view 600 depicting a seed item 602 and corresponding pivots 604 and 606. Seed item 602 may be an item (in this example, a dress) selected or found by user 104 at 502. In the example presented in view 600, the user may prefer the dress in a different color (e.g., in pink). In this case, user 104 initiates an online search (504) that includes a modification to the color of the dress (pivot=“pink”). In response, computing system 102 and server 106 may perform the search and present the results of the search to the user as pivots 604 and 606. As seen in view 600, pivots 604 and 606 show dresses in similar styles as the seed item 602, in a pink color as requested by user 104.

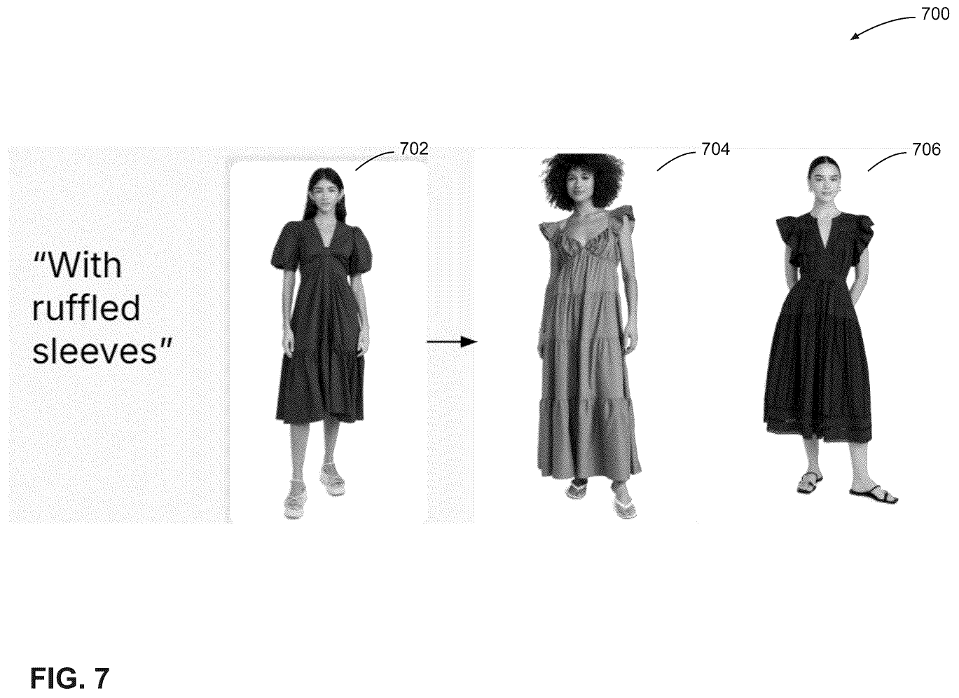

FIG. 7 is a view 700 depicting a seed item 702 and corresponding pivots 704 and 706. Seed item 702 may be an item (in this example, a dress) selected or found by user 104 at 502. In the example presented in view 700, the user may prefer the dress in a different style (e.g., with ruffled sleeves). In this case, user 104 initiates an online search (504) that includes a modification to the color of the dress (pivot=“with ruffled sleeves”). In response, computing system 102 and server 106 may perform the search and present the results of the search to the user as pivots 704 and 706. As seen in view 700, pivots 704 and 706 show dresses in similar styles as the seed item 702, with ruffled sleeves as requested by user 104.

Other example pivot instructions for various online searches may include:

For a bag: (for a bag with a gold chain) “with a silver chain, in black, and from Tori Burch (sic)”

For a dress: “In a mini cut, without the ruffles, and with a cutout”

For a top: “More formal, but strapless and more hugging”

For a sweater: “Something warmer, in a longer length, and thicker material”

For a specific brand: “From Altuzarra in richer colors and at least $250”

For a bag: “In rose gold and without the leather strap”

For a jacket: “This pattern on a jacket instead of a sweater”

Other features of product recommendation system include:

“More Like This” enables retrieval of products similar to the one a user selects, without requesting any specific attributes changed. Essentially, if user 104 likes a certain search result and wishes to see more items with properties similar to the item presented in the search result, then user 104 can enter a phrase such as “more like this” into a search bar, and product recommendation system 100 searches for items with similar properties to the item presented in the search result. This aspect uses the pivots feature to retrieve similar products.

In one aspect, the “More Like These” functionality can be run by product recommendation system 100 multiple times in order to retrieve products similar to a collection of multiple products.

Conversation management: In the “More Like This” embodiment, an LLM to is used describe in detail the product that the user 104 selected. That description is then used in the conversation history that another LLM call sees when deciding how to search. If a user asks for “More Like This” on a dark wash denim jacket, then follows up with “under $100”, product recommendation system 100 can continue to search for dark wash denim jackets but with the price filter applied.

Improvements in Capturing Color Intent: To further improve the accuracy of color pivots, the search can be augmented with more specific color information. For example, the ISCC-NBS color system can be incorporated into a product index used for the online search. This is a set of 13 basic colors (red, blue etc.) with a small set of adjectives (very dark, deep, very pale, light etc.). Together this set amounts to 267 colors. Products tagged (by an LLM) with natural language descriptive colors such as these implies that an LLM can be used to understand a color pivot in the context of the current color that user 104 searching for. For example, “this but darker” when a user is currently searching for green means that they are looking for “dark green”, “very dark green” etc. This color system is further augmented with metallic colors (such as gold, silver etc.) which allows the LLM, while tagging, to better classify products.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
receiving a user selection of a first item;
receiving a user request for an online search based on the first item, wherein the online search request includes at least one modification to at least one property of the first item;
conducting the online search; and
presenting one or more results of the online search to the user, wherein the results include at least a second item that differs from the first item with respect to the at least one property.

2. The method of claim 1, wherein the at least one property is any combination of a style, a color, a price, a brand, and a construction material.

3. The method of claim 1, wherein the user request is processed by at least one machine learning (ML) processor using natural language processing (NLP).

4. The method of claim 1, wherein conducting the online search includes:
inputting the at least one modification to an embedding model configured to encode the at least one modification;
the embedding model combining the encoded at least one modification with parameters associated with the online search request; and
an ML model predicting a region of latent search space that includes at least the second item based on the embedding.

5. The method of claim 4, further comprising training the ML model to perform the predicting.

6. The method of claim 1, wherein additional parameters such as seasonal appropriateness and qualities based on composition are included in the online search.

7. The method of claim 6, wherein the qualities based on composition include any combination of care instructions and materials.

8. The method of claim 1, wherein the modification is any of:
a near modification comprising a relatively minor change to the at least one property;
a far modification comprising a relatively large change to the at least one property; and
a subcategorical modification comprising the second item being in a different category as compared to the first item.

9. The method of claim 8, wherein the near modification is any of a pattern change, a feature change, or a style change.

10. The method of claim 8, wherein the far modification is any of a color change, a pattern change, a style change, or a silhouette change.

11. The method of claim 8, wherein the subcategorical modification is associated with the second item sharing a similar pattern as the first item.

12. The method of claim 11, wherein the first item is a jacket and the second item is a blouse.

13. A system comprising:
a computing system;
a server; and
a computer network communicatively coupling the computing system to the server, wherein the server is configured to:
receive a user selection of a first item from the computing system via the computer network;
receive a user request for an online search based on the first item from the computing system via the computer network, wherein the online search request includes at least one modification to at least one property of the first item;
conduct the online search; and
communicate one or more results of the online search to the computing system via the computer network, wherein the results include at least a second item that differs from the first item with respect to the at least one property; and
wherein the computing system is configured to present the results to the user.

14. The system of claim 13, wherein the at least one property is any combination of a style, a color, a price, a brand, and a construction material.

15. The system of claim 13, wherein the user request is processed by at least one machine learning (ML) processor using natural language processing (NLP).

16. The system of claim 13, wherein conducting the online search includes the server:
inputting the at least one modification to an embedding model configured to encode the at least one modification;
the embedding model combining the encoded at least one modification with parameters associated with the online search request; and
an ML model predicting a region of latent search space that includes at least the second item based on the embedding.

17. The system of claim 16, wherein the ML model is trained to perform the predicting.

18. The system of claim 13, wherein additional parameters such as seasonal appropriateness and qualities based on composition are included in the online search.

19. The system of claim 18, wherein the qualities based on composition include any combination of care instructions and materials.

20. The system of claim 13, wherein the modification is any of:
a near modification comprising a relatively minor change to the at least one property;
a far modification comprising a relatively large change to the at least one property; and
a subcategorical modification comprising the second item being in a different category as compared to the first item.

21. The system of claim 20, wherein the near modification is any of a pattern change, a feature change, or a style change.

22. The system of claim 20, wherein the far modification is any of a color change, a pattern change, a style change, or a silhouette change.

23. The system of claim 20, wherein the subcategorical modification is associated with the second item sharing a similar pattern as the first item.

24. The system of claim 23, wherein the first item is a jacket and the second item is a blouse.

25. A method to train an ML-based product recommendation system, the method comprising:
receiving a set of candidate pairs of items from a product database, wherein a first item in each candidate pair differs from a second item in the candidate pair by at least one property;
for each candidate pair, conducting pivot testing, the pivot testing further comprising:
testing a near pivot strategy associated with relatively small differences between the first item and the second item;
testing a far pivot strategy associated with relatively large differences between the first item and the second item; and
testing a subcategorical pivot strategy associated with the first item and the second item being in different categories;
receiving user-generated text associated with near pivots, far pivots, and subcategorical pivots as search parameters;
combining the pivot testing results with the user-generated text to generate a plurality of pairs and pivot text combinations;
storing the combinations as pivot training data; and
training an ML model using the pivot training data.

26. The method of claim 25, further comprising:
testing the results of the training; and
using testing results from the testing to further update the pivot training data.
